(19) United States
(12) Patent Application Publication
(10) Pub. No.: US 2010/0298586 A1
(43) Pub. Date: Nov. 25, 2010

(54) METHOD FOR PRODUCING FATTY ACID ALKYL ESTERS

(75) Inventors: Wulf Dietrich, Koln (DE); Stefan Grasser, Leverkusen (DE); Dieter Heinz, Shanghai (CN); Jürgen Karthaus, Solingen (DE); Leslaw Mleczko, Dormagen (DE); Heinrich Morhenn, Koln (DE); Rafael Watsitz, Essen (DE); Ren Wu, Munchen (DE)

Correspondence Address: GERSTENZANG, WILLIAM C.;NORRIS MCLAUGHLIN & MARCUS, PA, 875 THIRD AVE, 8TH FLOOR, NEW YORK, NY, 10022, US

(73) Assignee: BAYER TECHNOLOGY SERVICES GMBH, Leverkusen (DE)

(21) Appl. No.: 12/743,621

(22) PCT Filed: Dec. 16, 2008
(86) PCT No.: PCT/EP2008/010690

§ 371 Date: Jun. 21, 2010

(30) Foreign Application Priority Data
Dec. 19, 2007 (DE) 10 2007 061 872.9
Aug. 4, 2008 (DE) 10 2008 036 295.6

(51) Int. Cl. C11C 3/00

(52) U.S. Cl. 554/170

(57) ABSTRACT

Multistage process for the preparation of fatty acid alkyl esters.

Fatty acid alkyl esters, in particular the methyl esters, are important intermediates in oleochemistry. In Europe alone, over 4 million tonnes of vegetable oil methyl esters are produced per annum as starting materials primarily for surfactants. In particular, fatty acid methyl esters have an increasing importance as fuel for diesel engines. Industrial processes for the preparation of fatty acid alkyl esters, in particular fatty acid methyl esters, are virtually exclusively carried out nowadays using catalysts.

Starting materials for these processes that are often used and preferred, since they are cost-effective, are, besides vegetable oils, also other oils and fats of vegetable or animal origin, and also besides these oils and fats of natural origin, also spent waste fats and used food oils. However, many of these oils and fats are characterized in that, besides the main component, a triglyceride, they also comprise impurities, in particular free fatty acids.

Depending on the starting material and its composition with regard to free fatty acid and triglyceride, the reaction steps carried out in the course of the process are predominantly esterification reactions or transesterification reactions which in each case require different preferred catalyst systems and reaction conditions.

The catalysts used for the transesterification may be basic catalysts (e.g. alkali metal hydroxides, alkoxides, oxides, carbonates, anion exchangers), acidic catalysts (e.g. mineral acids, p-toluenesulphonic acid, boron trifluoride, cation exchangers) and enzymes (lipases). Preference is given to using basic catalysts for the transesterification.

The catalysts used for the esterification may be acidic catalysts.

Furthermore, for the catalysts, a distinction is made between heterogeneous and homogeneous catalysts, within which a further distinction can be made between acidic and basic catalysts.

The transesterification of oils and fats to give fatty acid alkyl esters is characterized by a complex phase behaviour since the phase ratios change greatly in the course of the reaction. The reaction starts with a two-phase system of triglyceride and alcohol. With increasing reaction progress and formation of ester, a homogeneous phase is formed, which in the further course with increasing glycerol formation becomes two-phase again, the light phase being the crude fatty acid alkyl ester and the heavy phase being a glycerol-rich phase.

The esterification is characterized by a generally lower required reaction temperature compared with the transesterification, this temperature depending in a decisive manner on whether a catalyst is used and if it is, which catalyst is used. The phase ratios of a pure esterification are generally simpler than those of the transesterification. Since, however, the components of the starting materials which are reacted in an esterification usually constitute the smaller fraction of the starting materials, this simplification is often compensated by corresponding purification steps before carrying out the esterification.

WO 2007/012097 discloses a process in which, by means of a liquid metal catalyst which comprises an alkaline earth metal salt of a carboxylic acid, it is possible to produce carboxylic acid esters by means of a transesterification or esterification reaction. The process is always characterized by the need to have to separate the catalyst from the respective reaction product since said catalyst should either be reused in the process, or the product containing the catalyst would not be commercially viable. Since the disclosed catalyst is a liquid catalyst, the processes which are disclosed as useful for separating off the catalyst are complex and thus make the overall process economically unfavourable. For separating off water and alcohols from the disclosed process, the option of a membrane method is also explained which, according to the disclosure, can also be used for separating off the glycerol phase from the fatty acid ester phase.

WO 2006/029655 discloses a process for the transesterification of starting materials which likewise involves salts as catalysts. In contrast to WO 2007/012097, the problem of separating off a catalyst from the reaction mixture within the process here is solved through the use of salts which are characterized in that they are insoluble in alcohols and fatty acids, and only soluble to a slight extent in water. Furthermore, the salts are selected such that they decompose under reaction conditions, meaning that they can no longer be found in the reaction product in a troublesome concentration. The process is furthermore characterized in that, according to the disclosure, an esterification of free fatty acids of the starting materials is possible at the same time as a transesterification. Here, however, the amount of catalyst used must be increased according to the fraction of free fatty acids, where, according to the disclosure, the catalyst used for this purpose is inactivated and therefore has to be replaced. Separating off the glycerol phase from the reaction product is only disclosed by means of a separating funnel. Overall, the disclosed process cannot be utilized efficiently on account of the described limitations with regard to catalyst consumption in the case of starting materials with an increased fraction of free fatty acids, and there is a lack of suitable methods for providing the resulting reaction product in an economically favourable manner and with adequate product purity.

WO 1998/56747 discloses a process for the transesterification of starting materials which uses heterogeneous, basic catalysts. Preferably, these heterogeneous basic catalysts comprise oxides of the alkaline earth metals. According to the disclosure, the transesterification reaction of the process is carried out at temperatures between 25 and 260° C. at ratios of alcohol to triglyceride of from 0.2 to 20, and a fraction between 0.05 and 10% of the catalyst in the overall reaction mixture. According to the disclosure, the catalyst is used in the form of a powder, resulting in a suspension reaction. Although separating off solids from liquids according to the disclosure of WO 2007/012097 is simpler, less energy-intensive and thus advantageous, the need for a further separation step for separating off the catalyst is nevertheless a disadvantage which reduces the economic efficiency of the process. Furthermore, no possibility of a esterification reaction is disclosed.

WO 2006/050925 discloses a process which likewise uses a heterogeneous, basic catalyst, in the presence of which the starting materials are transformed with monoalcohols to fatty acid esters and glycerol at temperatures between 100° C. and 250° C. and at ratios of monoalcohol to starting material between 4 and 30. The reaction can also be carried out in a fixed-bed reaction. According to the disclosure, the starting materials must comprise more than 1% by weight of free fatty acid. However, the disclosed process is highly disadvantageous with regard to its yield when increased fractions of free fatty acids are present in the starting materials since the disclosed catalyst catalyses the esterification reaction of the free fatty acids only to a slight extent, if at all. The conversions achieved are in this case even lower than would be expected for a high conversion of the triglycerides. Thus, in the process of WO 2006/050925, no esterification takes place to a notable degree. It is disclosed that it is possible to separate off the glycerol. An indication as to how this can advantageously happen is not given. Overall, the disclosed process is disadvantageous when highly contaminated starting materials are used, in particular when high fractions of free fatty acids are present in the starting materials since then the required product grades which would be required for a commercial exploitation of the product are no longer achieved.

U.S. Pat. No. 5,908,946 discloses a process by means of which fatty acid alkyl esters and glycerol can be obtained in high purity in 1 to 3 stages. The disclosed process uses a basic catalyst comprising zinc oxide and can be carried out continuously in a fixed bed. It is disclosed that in principle nothing stands in the way of using starting materials with fractions of free fatty acids, but that, when they are used, there is a risk of saponification, meaning that a transesterification reaction is preferably preceded by an esterification reaction with glycerol which is characterized in that glycerides are preferably formed in it which are subsequently transesterified. According to the disclosure, the glycerol liberated in the transesterification is separated off by means of decanting. A disadvantage of this process is the fact that basic catalysts are known to not catalyse the esterification as well as acidic catalysts, meaning that high impurities in the starting materials with free fatty acids again lead to greatly reduced conversions and yields based on the fatty acid alkyl ester. Furthermore, the separation process of decanting is a process which is based on the phase separation of two liquids on the basis of a density divergence and a mutual poor solubility. However, the person skilled in the art is aware that a solution of two liquids in one another can never be prevented since there is always a partition coefficient of the two phases in one another which represents a real number (see e.g. Klaus Sattler, “Thermische Trennverfahren [Thermal Separation Processes]”, Wiley VCH, 3rd ed., ISBN-10: 3-527-30243-3). Accordingly, the purity of the ester phase and the purity of the glycerol phase after a decanting are not adequate in some circumstances, but can no longer be further improved within the separation process of decanting.

In view of the disadvantages of the prior art, it is thus a technical object to provide a process which, starting from starting materials which comprise at least triglycerides of fatty acids and/or free fatty acids, but is unrestricted as regards the fractions of these in the starting material, and which makes it possible to produce fatty acid alkyl esters and glycerol in high yield.

It has surprisingly been found that a process for the preparation of fatty acid alkyl esters starting from starting materials which include at least a fraction of triglycerides of fatty acids and/or a fraction of free fatty acids, which is characterized in that it involves at least the steps:
a) reaction of the free fatty acids with an alcohol to give fatty acid alkyl esters in the presence of an acidic, heterogeneous catalyst in the form of an esterification reaction,
b) if appropriate, removal of water and/or alcohol from the product of step a),
c) reaction of the triglycerides with an alcohol to give fatty acid alkyl esters in the presence of a basic, heterogeneous catalyst, in the form of a transesterification reaction,
d) if appropriate, removal of the alcohol from the product of step c),
e) separation off of glycerol using a hydrophobic membrane,
   makes this possible.

In connection with the present invention, starting materials refer to all substances which comprise at least a fraction of triglycerides of fatty acids and/or a fraction of free fatty acids. Possible starting materials are, for example, oils and fats of vegetable or animal origin, such as, for example, rapeseed oil, soya oil, palm oil or jatropha oil as vegetable oils, or coconut fat as vegetable fat, or fish oil as oil of animal origin, and also beef tallow, or pig grease as fats of animal origin.

For this invention, fatty acids are understood as meaning monocarboxylic acids, i.e. compounds which consist of a carboxyl group and of a hydrocarbon chain, where the hydrocarbon chain contains at least ten carbon atoms. The hydrocarbon chain can be branched or unbranched. i.e. the carbons of the hydrocarbons may be ordered linearly alongside one another, or may not. The hydrocarbon chain may be saturated or unsaturated. i.e. in each case between the at least ten carbon atoms of the hydrocarbon chain, the covalent bond can comprise one or more bonding electron pairs. In connection with the present invention, the fatty acids also include the substance group known to the person skilled in the art under the name “lipids”.

Preferred fatty acids are saturated or unsaturated monocarboxylic acids which contain between 14 and 20 carbon atoms, in the hydrocarbon chain.

Within the context of the present invention, all substances comprising a glycerol constituent to which at least one fatty acid according to the above definition is covalently bonded by means of an ester bond are referred to as triglycerides. Such esters are often the main constituents of the starting materials given above as an example.

Free fatty acids are fatty acids which are additionally characterized by the fact that they are not the result of one of the reactions of this invention.

The alcohols used according to the process according to the invention are usually monoalcohols comprising at most five carbon atoms. Preference is given to monoalcohols with one to four carbon atoms, such as, for example, methanol, ethanol, 1-propanol, 2-propanol etc. Particular preference is given to methanol.

The acidic, heterogeneous catalyst used in step a) according to the invention usually comprises polymers with acidic side groups. Preference is given to acidic ion exchanger resins. Particular preference is given to the acidic ion exchanger resins sold by Rohm and Haas under the trade name Amberlyst®.

The acidic, heterogeneous catalyst according to the invention can be in the form of particle beds or in monolithic form. Preference is given to particle beds. Particular preference is given to particle beds of the acidic, heterogeneous catalyst which are present as fixed bed in the reaction zone. The particles of the acidic, heterogeneous catalyst here very particularly preferably have an average diameter of about 800 μm. The person skilled in the art is generally familiar with the methods and devices with which he can produce a fixed bed in the reaction zone. A nonexhaustive example which may be mentioned is the fixing of the particle bed of the acidic, heterogeneous catalyst by sieves of smaller mesh width than the diameter of the particles of the acidic, heterogeneous catalyst.

The use of a fixed bed comprising particle beds is particularly advantageous since, through this, a high surface area of the acidic, heterogeneous catalyst can be achieved in the reaction zone at which the reaction according to step a) according to the invention can be carried out. At the same time, the reaction product is not contaminated with residues of the acidic, heterogeneous catalyst. A general advantage of reactions over fixed beds is that the device comprising the fixed bed—the fixed-bed reactor—is characterized by small dimensions with simultaneously high conversion. The object of a high space-time yield is thus achieved herewith particularly advantageously.

The reaction according to step a) of the process according to the invention can take place at temperatures between 50° C. and 120° C. Preference is given to temperatures between 60° C. and 100° C. Particular preference is given to a temperature of about 85° C.

Although higher temperatures would lead to a higher conversion per time unit according to scientific laws generally known to the person skilled in the art, they demand an energy input which, under certain circumstances, no longer allows an economically favourable operation of the process and, moreover, leads, in some circumstances, to an inactivation of the acidic, heterogeneous catalyst which, being a polymer, can be structurally damaged at excessively high temperatures. The use of a different acidic, heterogeneous catalyst to that particularly preferred can justify much higher temperatures than those emphasized as being preferred in this process.

A reaction according to step a) at the stated temperatures and with further use of the preferred catalysts, however, is particularly advantageous since, through the combination of these features, the object of the high space-time yield in relation to the energy used can advantageously be achieved.

Furthermore, the reaction according to step a) of the process according to the invention can take place at pressures between 1 bar and 10 bar. Preference is given to a pressure between 2 bar and 7 bar. Particular preference is given to a pressure of about 5 bar.

The stated pressures according to the invention and preferred pressures arise from the vapour pressures of the alcohols used in each case, such as, for example, ethanol or methanol at the temperatures according to the invention and preferred temperatures of the process. Lower pressures lead to an outgassing of the alcohol from the reaction solution, meaning that it is no longer available to the full extent for the reaction over the acidic heterogeneous catalyst. Higher pressures are energy-intensive and thus economically unfavourable in some circumstances. This gives rise to an alternative, preferred embodiment in which the reaction according to step a) of the process according to the invention can likewise preferably be carried out at a pressure approximately corresponding to the vapour pressure of the alcohol used in the process at the temperatures according to the invention or at the preferred temperatures. In the course of step a) of the process according to the invention, the pressure is particularly preferably somewhat higher than the vapour pressure of the alcohol used in the process at the temperatures according to the invention or at the preferred temperatures.

The residence time of starting material comprising the free fatty acids and alcohol in step a) of the process according to the invention is usually between 5 and 40 minutes. Preferably, the residence time is between 10 and 20 minutes.

In the context according to the invention (e.g. in the case of a discontinuous reaction), residence time can be the period of time of the reaction solution in the device in which the reaction according to step a) of the process according to the invention is carried out, or can (e.g. in the case of a continuous reaction) refer to the average period of time from a fluid element entering the reaction zone in which the reaction according to step a) of the process according to the invention is carried out until the same fluid element exits the reaction zone.

Consequently, the reaction according to step a) of the process according to the invention can be carried out continuously or discontinuously. Preferably, step a) of the process according to the invention is carried out continuously.

The residence times are tailored to the boundary conditions according to the invention of the process (e.g. pressure, temperature, amount of alcohol etc.) and constitute, based on this, customary and preferred values which together achieve the object of the invention in an advantageous manner. In the event of a change in the boundary conditions of step a) of the process according to the invention, the person skilled in the art can thus undertake, in a simple manner, an appropriate adaptation of the residence time through targeted experiments in order to achieve the disclosed results of step a) of the process according to the invention.

The reaction according to step a) of the process according to the invention usually takes place at a molar ratio of from 1:1 to 40:1 of the alcohol used to the free fatty acids present in the starting material. Preference is given to a molar ratio of from 10:1 to 30:1, and particular preference is given to a molar ratio of about 20:1.

A lower molar ratio of alcohol to free fatty acid than 1:1 is disadvantageous since, as a result, not even the stoichiometric conversion to fatty acid alkyl esters can be achieved. Higher molar ratios of alcohol to free fatty acid are disadvantageous because in at least one of the latter steps, at least the alcohol has to be separated off from the rest of the product. According to laws generally known to the person skilled in the art, separation operations always require the input of energy into the system which is to be separated, as a result of which an increase in the molar ratio above a degree which is still suitable for having a notable positive influence on the conversion is economically unfavourable. The upper limit of the molar ratio of alcohol to free fatty acid is therefore an economically sensible limitation upon whose further increase the conversion can no longer be notably increased under the given different boundary conditions of the process according to the invention.

Step a), disclosed here, of the process according to the invention and its preferred variants achieve a conversion based on the free fatty acids of at least 90%. Upon taking into consideration the preferred embodiments and developments of the process according to the invention, even a conversion based on the free fatty acids of at least 97% is achieved by means of step a).

In a preferred development of step a) of the process according to the invention, the reaction according to step a) involves at least one further reaction. Particular preference is given to one further reaction.

The further reaction involves at least one reaction according to step a) and its preferred embodiments with regard to pressure, temperature, residence time, acidic, heterogeneous catalyst and at least one prior separation off of water and/or alcohol.

The separation can take place by methods known to the person skilled in the art, such as, for example, distillation, or according to steps b) and/or e) of the process according to the invention and is preferably carried out such that the remaining substance stream comprises less than 2% by weight, particularly preferably less than 0.05% by weight, of water. Preference is given to an embodiment according to the preferred variants of steps b) and/or e). In the case of the use of methods known to the person skilled in the art, such as, for example, distillation, the means for achieving the required fractions of water are generally known.

It is likewise preferred to separate off only the water and to pass the entire remaining substance stream to the at least one further reaction, if appropriate with the addition of further alcohol. If further alcohol is added, which is particularly preferred, then the amount of alcohol removed by the separation is very particularly preferably added again.

The execution of at least one further reaction with prior separation of preferably only water is particularly advantageous since, as a result of this, the conversion can be further increased based on the free fatty acids. As a result, the object of a particularly pure product of the process according to the invention can be achieved particularly advantageously.

It may be advantageous to carry out the further reaction more than once if in so doing, the object of a particularly pure product while retaining a high space-time yield of the process according to the invention can be better achieved.

If a separation according to step b) of the process according to the invention, e.g. in the course of the at least one further reaction according to a preferred development of step a) of the process according to the invention is envisaged, then this can take place by methods known to the person skilled in the art, such as, for example, distillation, or by means of a membrane method. Preferably, before carrying out step c) of the process according to the invention, a separation according to step b) is envisaged.

Preference is likewise given to a separation according to step b) by means of a membrane method, operated in accordance with methods known to the person skilled in the art for achieving the desired separation result, as has been disclosed, for example, previously with a maximum of 2% by weight of water in the remaining substance stream. Particular preference is given to a separation according to step b), such that less than 20 000 ppm of water are present in the remaining substance stream from step b).

The separation according to step b) of the process according to the invention can take place continuously or discontinuously. Preferably, the separation takes place continuously.

The reaction according to step c) of the process according to the invention takes place using a basic, heterogeneous catalyst which usually comprises salts and/or oxides of the metals selected from the list aluminium, calcium, chromium, iron, gallium, cobalt, copper, lanthanum, magnesium, manganese, nickel, vanadium, zinc and mixtures thereof. Preference is given to basic, heterogeneous catalysts which include oxides and/or salts, carbonates or hydroxycarbonates of these metals, and mixtures thereof.

Particularly preferably basic, heterogeneous catalysts are substances which are obtained from hydrotalcites by calcination.

Hydrotalcites refer to sheet minerals composed of tri- and divalent cations of metals such as, for example, aluminium and magnesium, as are generally known to the person skilled in the art, for example, under the chemical formula Mg₆Al₂(CO₃)(OH)₁₆.4H₂O. Hydrotalcites can be prepared with different ratios of the metals Me³⁺ and Me²⁺. In connection with the present invention, pyroaurite, sjörgrenite, manasseite, stichite, and the substances according to formula (I):

[Me²⁺_{X}Me³⁺(OH)_{Y}][(CO₃)_{Z}.nH₂O] (I)

where 1≦X≦6, Y>Z, Y+2·Z=2·X+3 and 0<n<10 and
where Me²⁺ can be divalent cations of the metals magnesium, calcium, iron, nickel, chromium, manganese, zinc, cobalt or copper and
where Me³⁺ may be trivalent cations of the metals aluminium, iron, nickel, chromium, cobalt, gallium or vanadium, are also referred to as hydrotalcites.

In connection with the present invention, calcination refers to the heating of, for example, hydrotalcites to obtain mixed oxides. Further heating in the course of heating leads to a structural rearrangement of the mixed oxides to give spinell structures of the mixed oxides. The particularly preferred basic heterogeneous catalysts from hydrotalcites obtained by calcination are usually characterized by an at least partial rearrangement of the mixed oxides to the spinell structure. The calcination is usually carried out at temperatures of from 400° C. to 1100° C.

In a likewise particularly preferred alternative embodiment of step c) of the process according to the invention, a basic heterogeneous catalyst is used which comprises lanthanum oxide (La₂O₃) and aluminium oxide (Al₂O₃) and, if appropriate, magnesium oxide (MgO) and which is characterized in that the sum of the mass fractions of lanthanum oxide and magnesium oxide is between 2 and 20%.

In connection with the present invention, the sum of the mass fractions of lanthanum oxide and magnesium oxide in the catalyst refer to mass fractions of La₂O₃ and MgO of the total catalyst mass calculated from the mass of lanthanum and magnesium in the catalyst. The mass fractions of lanthanum oxide and magnesium oxide should therefore not be deemed to be a restriction with regard to the actual presence of the pure oxide phases. This also applies below for data relating to other constituents of the catalyst according to the invention, such as, for example, aluminium as aluminium oxide (Al₂O₃).

The sum of the mass fractions of lanthanum oxide and magnesium oxide is preferably between 5 and 20%. Particularly preferably between 8 and 15%.

The catalyst according to the preferred alternative embodiment can also comprise only lanthanum oxide and aluminium oxide. However, the catalyst preferably comprises lanthanum oxide, magnesium oxide and aluminium oxide.

The presence of all three oxides is particularly advantageous since aluminium oxide can serve as carrier with slight basic properties compared to the other two oxides, and can form stable mixed phases with the two other oxides.

The catalyst according to the preferred alternative embodiment particularly preferably comprises between 5 and 15% by weight of lanthanum oxide and between 1 and 10% by weight of magnesium oxide, but such that in total not more than 20% by weight of the two oxides are present.

The catalyst very particularly preferably comprises between 8 and 12% by weight of lanthanum oxide and less magnesium oxide than lanthanum oxide.

Such catalysts are particularly advantageous since the lanthanum oxide then forms stable mixed phases with aluminium oxide and also the magnesium oxide can then form stable mixed phases with the aluminium oxide, although, compared with the mixed phase of the lanthanum oxide with the aluminium oxide, it is not as stable toward “leaching” as that specified previously, but is co-stabilized by the lanthanum oxide and aluminium oxide mixed phase.

In connection with the present invention, “leaching” refers to the tendency of basic heterogeneous catalysts to partially dissolve under the reaction conditions or even to form with the reaction mixture reaction products which are found again in the reaction product.

Particularly in the case of catalyst compositions which comprise magnesium oxide (MgO) and/or aluminium oxide (Al₂O₃), a leaching and/or undesired soap formation was observed.

The tendency to form soaps is obviously independent of the achievable yields and selectivities, but makes a process economically unfeasible due to the need to separate off the undesired by-products (Peterson, G. R., Scarrah, W. P.: “Rapeseed Oil Transesterification by Heterogeneous Catalysis”, Journal of the American Oil Chemists' Society (1984) 61 (10)).

It is therefore preferred if the catalyst is present at least partially in a perovskite mixed phase of the lanthanum oxide and aluminium oxide and optionally the magnesium oxide and aluminium oxide is present at least partially in a spinell mixed phase. Lanthanum oxide and aluminium oxide are particularly preferably present at least partially in a perovskite mixed phase and magnesium oxide and aluminium oxide are present at least partially in a spinell mixed phase.

The detection of such mixed phases, or the different, pure oxidic phases is carried out by methods generally known to the person skilled in the art, such as, for example, X-ray spectroscopy (XRD).

Particularly preferably, the aluminium oxide is present at least partially as δ-Al₂O₃ and the mass fraction of magnesium oxide is 0%.

These preferred and particularly preferred variants are particularly advantageous because it has surprisingly been found that the presence of mixed phases and/or δ-Al₂O₃ stabilizes the catalyst according to the invention in particular against a “leaching” and at the same time permits a high activity of the catalyst for the heterogeneous catalytic transesterification of fats and/or oils with lower alcohols to give fatty acid alkyl esters for combustion in diesel engines.

Within the particularly preferred alternative embodiment, such a catalyst has a fraction of at least 80% mesopores, preferably a fraction of at least 90% mesopores.

In connection with the present invention, mesopores refer to pores with a diameter of from 2 nm to 50 nm.

The fraction of mesopores can be ascertained easily by methods generally known to the person skilled in the art, such as, for example, mercury porosimetry.

Such a fraction of mesopores is particularly advantageous because, as a result of this, an optimum specific surface area of the catalyst can be achieved compared to the simple penetrability of the pore volume.

If only a few mesopores are present, but many micropores are present, then the catalyst has a high specific surface area, although the pore channels are so small that the reactants reach the active centres of the catalyst more slowly, which adversely influences a rapid reaction in the presence of the catalyst.

If a few mesopores are present, but many macropores are present, then although the reactants easily penetrate the catalyst and thus rapidly reach the active centres of the catalyst, the specific surface area of the catalyst is smaller, meaning that fewer active centres are available. This results in the need to use more catalyst material, which is economically disadvantageous.

The catalysts described in this particularly preferred alternative embodiment are in particular therefore particularly advantageous because they allow an activity, calculated from conversion of fats and oils per time and per mass of catalyst, of more than 0.2 kg/kg_{catalyst}·h, in preferred embodiments from 2 to 12 kg/kg_{catalyst}·h.

All basic heterogeneous catalysts according to the invention can be present in the form of particle beds or in monolithic form. Preference is given to particle beds. Particular preference is given to particle beds of the basic, heterogeneous catalyst which are present as fixed bed in the reaction zone. In this connection, the particles of the basic heterogeneous catalyst very particularly preferably have an average diameter of from about 0.5 mm to 3 mm. The methods and devices with which a person skilled in the art can create a fixed bed in the reaction zone are generally known to him. A nonexhaustive example which may be mentioned is the fixing of the particle bed of the basic heterogeneous catalyst by sieves of lower mesh width than the diameter of the particles of the heterogeneous catalyst.

The use of a fixed bed comprising particle beds is particularly advantageous since, as a result of this, a high surface area of the basic, heterogeneous catalyst in the reaction zone can be achieved over which the reaction according to step c) according to the invention can be carried out. At the same time, the reaction product is not contaminated with remnants of the basic, heterogeneous catalyst.

The reaction according to step c) of the process according to the invention can take place at temperatures between 50° C. and 250° C. Preference is given to temperatures between 180° C. and 220° C. Particular preference is given to a temperature of about 200° C.

Although higher temperatures would lead to a higher conversion per time unit, according to scientific laws generally known to the person skilled in the art, they require an energy expenditure which, in some circumstances, no longer permits an economically favourable operation of the process.

Furthermore, the reaction according to step c) of the process according to the invention can take place at pressures between 1 bar and 150 bar. Preference is given to a pressure between 25 bar and 75 bar. Particular preference is given to a pressure of about 50 bar.

The stated pressures according to the invention and preferred pressures arise from the vapour pressures of the alcohols used in each case, such as, for example, ethanol or methanol at the temperatures according to the invention and preferred temperatures of the process. Lower pressures lead to an outgassing of the alcohol from the reaction solution, meaning that this is no longer available to the full extent for the reaction over the basic heterogeneous catalyst. Higher pressures are energy-intensive and are thus, in certain circumstances, economically unfavourable. This results in an alternative preferred embodiment according to which the reaction as in step c) of the process according to the invention can likewise preferably be carried out at a pressure approximately corresponding to the vapour pressure of the alcohol used in the process at the temperatures according to the invention or the preferred temperatures. The pressure in the course of step c) of the process according to the invention is particularly preferably somewhat higher than the vapour pressure of the alcohol used in the process at the temperatures according to the invention or preferred temperatures.

The residence time of starting material comprising the triglycerides and alcohol in step c) of the process according to the invention is usually between 5 and 90 minutes. Preferably, the residence time is between 20 and 50 minutes.

In the context according to the invention (e.g. in the case of a discontinuous reaction), residence time can include the time the reaction solution spends in the device in which the reaction as in step c) of the process according to the invention is carried out, or (e.g. in the case of a continuous reaction) the average time from a fluid element entering the reaction zone in which the reaction as in step c) of the process according to the invention is carried out until the same fluid element leaves the reaction zone.

Consequently, the reaction as in step c) of the process according to the invention can be carried out continuously or discontinuously. Preferably, step c) of the process according to the invention is carried out continuously.

The residence times are matched to the boundary conditions according to the invention of the process (e.g. pressure, temperature, amount of alcohol etc.) and, based thereon, represent customary and preferred values. In the event of changing the boundary conditions of step c) of the process according to the invention, the person skilled in the art is thus able, in a simple manner, without further inventive activity, to undertake a corresponding adaptation of the residence time through targeted experiments in order to achieve the disclosed results of step c) of the process according to the invention.

The reaction according to step c) of the process according to the invention usually takes place at a molar ratio of from 3:1 to 30:1 of the alcohol used to the triglycerides present in the starting material. Preference is given to a molar ratio of from 5:1 to 25:1, particularly preferably a molar ratio of about 23:1.

A lower molar ratio of alcohol to triglycerides than 3:1 is disadvantageous since, as a result of this, only in exceptional cases can the stoichiometric conversion to fatty acid alkyl esters be achieved (e.g. when the triglycerides according to the invention have only at most two ester bonds). Higher molar ratios of alcohol to triglycerides are disadvantageous because in at least one of the later steps, at least the alcohol has to be separated off again from the remaining product. According to principles generally known to the person skilled in the art, separation operations always require the input of energy into the system which is to be separated, for which reason an increase in the molar ratio above a degree which is still suitable for having a notable positive influence on the conversion is economically unfavourable. The upper limit of the molar ratio of alcohol to triglycerides thus represents an economically sensible limitation, upon whose further increase the conversion can no longer be notably increased under the stated other boundary conditions of the process according to the invention.

Step c) disclosed here of the process according to the invention and its preferred variants achieve a conversion based on the triglycerides of at least 80%. Upon taking into consideration the preferred embodiments and developments of the process according to the invention, even a conversion based on the triglycerides of at least 90% is achieved by means of step c).

In a preferred development of step c) of the process according to the invention, the reaction according to step c) includes a further reaction. This can be carried out continuously or discontinuously like the reaction according to step c). Preferably, the further reaction is carried out continuously.

The further reaction involves a reaction according to step c) and its preferred embodiments with regard to pressure, temperature, residence time, basic, heterogeneous catalyst and a prior separation off of glycerol.

The separation usually takes place by means of a multistage method, involving flash evaporation and subsequent separation of glycerol by means of phase separation.

The flash evaporation is usually carried out in the devices generally known to the person skilled in the art, such as, for example, falling-film evaporators.

Since the alcohol is a solvent for glycerol and is miscible in high fractions with fatty acid alkyl esters, the flash evaporation is preferably carried out such that the fraction of the alcohol is reduced to the extent that the solubility of the glycerol in the alcohol is not reached. The alcohol is preferably condensed and passed either to step a) or step c) of the process according to the invention.

The corresponding solubilities are known to the person skilled in the art from the relevant literature, such as, for example, the VDI heat atlas, meaning that an appropriate adaptation of the operating parameters, e.g. of a falling-film evaporator, is possible for the person skilled in the art in an easy manner.

The separation off of glycerol by means of phase separation is preferably carried out at temperatures between 60° C. and 150° C. The phase separation is likewise preferably carried out, as also in step a), at a pressure corresponding to the vapour pressure of the alcohol. The pressure is particularly preferably somewhat higher than the vapour pressure of the alcohol used in the process.

The glycerol is preferably passed to step e) of the process according to the invention.

Further alcohol is likewise preferably passed to the further reaction following the separation. The amount of alcohol removed during the separation is particularly preferably introduced again. Methods to determine the amount of alcohol removed are generally known and include, for example, measuring the refractive index of the removed substance stream.

The carrying out of a further reaction with prior removal of glycerol is particularly advantageous because, as result of this, the conversion based on the triglycerides can be further increased, which achieves the object of the high space-time yield while further taking into consideration the purity of the process product in a particularly advantageous manner.

If a removal of the alcohol from the product of step c), according to step d) of the process according to the invention is envisaged, which is preferred, then this is particularly preferably carried out after the above-described process of flash evaporation or distillation and very particularly preferably with further condensation of the alcohol and its introduction into step a) or step c) of the process according to the invention.

The removal of the alcohol according to step d) of the process according to the invention is preferred because the alcohol is miscible with fatty acid alkyl esters and at the same time is a solvent for the glycerol. Step e) according to the invention involves a liquid-liquid separation using a hydrophobic membrane. It is typical of processes of this type that their separation result depends inter alia on the presence of two separate liquid phases. If, therefore, the fraction of alcohol in step e) of the introduced substance stream according to the invention is too high, there are no separate fluid phases and the separation result of step e) of the process is disadvantageous.

The hydrophobic membrane used in step e) according to the invention is usually a polymer membrane or ceramic membrane or a membrane made of a polymer-ceramic composite. Particular preference is given to hydrophobic membranes made of ceramic, polymer, or composite materials made of polymer and ceramic which have a coating with hydrophobic material, such as, for example, perfluorinated polymers (PTFE, PVDF) or hydrophobic polymers (polypropylene) or whose surface has been hydrophobicized through the use of isocyanates or silanes.

On account of its nature, the hydrophobic membrane exhibits a high separation rate between the product phase comprising polar glycerol and the product phase comprising nonpolar fatty acid alkyl ester, the latter being able to permeate through the membrane whereas the former cannot.

The hydrophobic membrane can have a pore width of from 0.05 μm to 10 μm, preferably from 0.1 μm to 5 μm.

The use of one of the membranes according to the invention or preferred membranes is particularly advantageous because, in so doing, any impurities still present in the substance stream (e.g. salts etc.) remain in the polar phase and did not arise in the product, the fatty acid alkyl esters.

The separation according to step e) of the process according to the invention can take place continuously or discontinuously. Preference is given to a continuous separation.

The separation according to step e) is particularly advantageous because, as a result of this, glycerol can be obtained in highly pure form, which is either sold directly, in which case it increases the economic feasibility of the process according to the invention, or which is converted in a further reaction either to a form which can be utilized in the process according to the invention, or is converted to a higher-value substance which is then sold.

Steps a) and c) of the process according to the invention do not have to be carried out in succession in the order implied by the above-stated illustration under certain circumstances. Rather, this illustration describes only the necessarily characterizing process steps of the process according to the invention. Steps a) and c) can, for example, also be carried out in parallel. Preferred embodiments and developments of the process according to the invention which illustrate this in more detail are disclosed below.

In a preferred development of the process according to the invention, prior to carrying out step a), a separation according to a step f) is carried out in which free fatty acids are separated from triglycerides such that the free fatty acids are passed to step a) and the triglycerides are passed to step c) of the process according to the invention simultaneously.

The separation according to step f) preferably takes place by stripping and subsequent condensation of the stripping gas. The stripping gas used is preferably steam. Stripping is a method generally known to the person skilled in the art which is characterized by the entrainment of substances from substance mixtures by means of a gas or gas mixture.

The stripping particularly preferably takes place at a pressure of from 2 to 5 mbar. The stripping likewise particularly preferably takes place at a temperature of from 230° C. to 270° C.

The subsequent condensation of the stripping gas preferably takes place in two stages and involves, in a first stage, the condensation of optionally entrained impurities, such as, for example, triglycerides, and, in a second stage, the condensation of the free fatty acids. The condensate comprising the free fatty acids is passed to step a) of the process according to the invention.

Carrying out step f) is advantageous since in so doing it is possible to avoid the largely inert triglycerides for step a) of the process according to the invention having to pass through this process step without reaction. As a result of the increased amount of the substance stream to be passed through step a) of the process according to the invention, the devices in which this step is carried out would have to be made larger, otherwise a conversion of the triglycerides would take place to a significant extent in this step. This would be economically unfavourable. The carrying out of step f) thus achieves the object of achieving a high space-time yield in a particularly advantageous manner.

In a further preferred development of the process according to the invention, after step e) of the process according to the invention, a further step g) is carried out which is characterized in that the glycerol obtained from step e) is passed to a further reaction. The further reaction is preferably a combustion. The energy produced in the combustion can be utilized in the form of heat by converting it by means of methods known to the person skilled in the art either to electrical energy, or by using it directly for providing the temperature required for the operation of steps a) and/or c) according to the invention.

It is likewise possible for the further reaction according to step g) to involve other reactions than that of combustion.

The implementation of step g) as combustion is particularly advantageous because, as a result of this, the energy expenditure which has to flow into the process according to the invention from outside is reduced and thus the operating costs of the process are reduced.

Finally, it may be noted that all of the disclosed steps of the process according to the invention, and also their preferred embodiments and developments and thus also the entire process can be carried out discontinuously or continuously. Preference is given to the continuous operation of the steps, their preferred embodiments and developments and of the overall process.

The product obtained from the process, the fatty acid alkyl ester, is present in high yield and purity, meaning that it can be used preferably directly, or following the addition of additives for its refining, as fuel for diesel engines.

The invention is illustrated in more detail below by reference to examples without, however, being limited thereto.

### EXAMPLES

### Example 1

### Process with Single Reaction

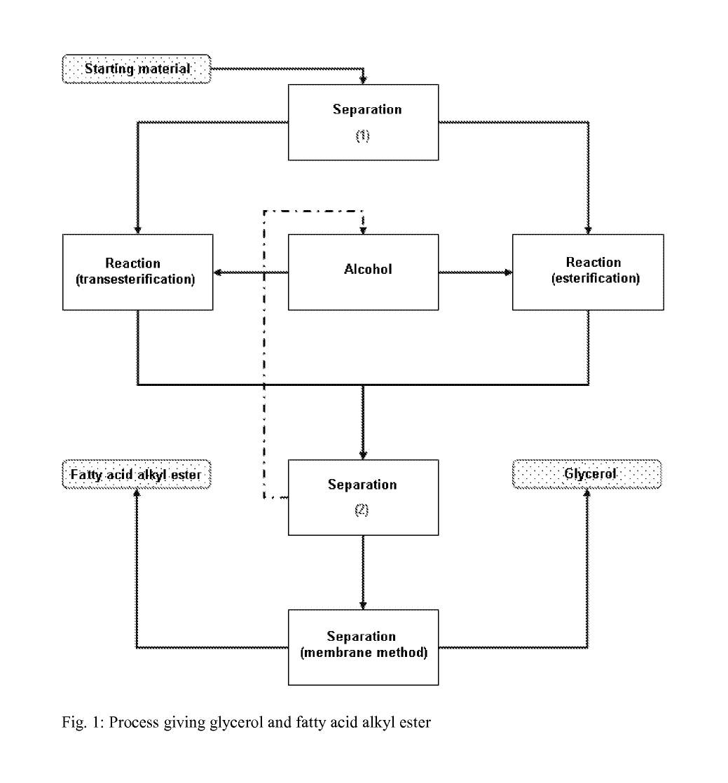

FIG. 1 shows a process according to the invention in which firstly the starting material, e.g. animal or vegetable oils and/or fats, or mixtures thereof, are subjected in a first step to a first separation (1), in which free fatty acids are separated from triglycerides. Possible embodiments of this separation are, for example, stripping with steam etc. The resulting triglycerides are then passed to a reaction (transesterification) and the resulting free fatty acids are passed to a reaction (esterification). Alcohol (e.g. methanol) is passed both to the reaction (transesterification) and also to the reaction (esterification). The product from reaction (transesterification) and reaction (esterification) is passed to a separation (2) e.g. in the form of an alcohol distillation, so that the removed alcohol can optionally be passed again to the alcohol. The two-phase product resulting from separation (2) is then subjected to a separation (membrane method) so that two substance streams fatty acid alkyl ester and glycerol are obtained in pure form.

### Example 2

### Process with Further Reaction

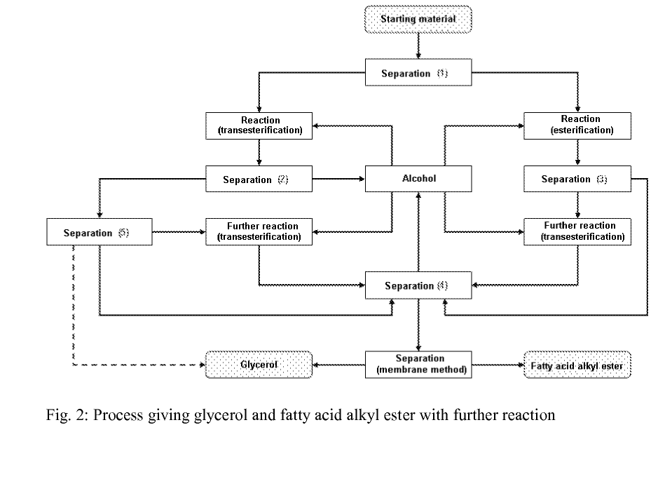

FIG. 2 shows a preferred development of the process according to the invention in which firstly the starting material is again subjected to a first step in the form of a separation (1), so that again free fatty acids are separated from triglycerides.

The triglycerides are then passed to a reaction (transesterification), the product stream from this first reaction (transesterification) is passed to a separation (2) e.g. in the form of a flash evaporation, in which at least some of the alcohol is separated from the remaining substance stream. This alcohol can then be passed again to the reservoir of alcohol and be further used in the process. The remaining substance stream is then passed to a separation (5), e.g. in the form of e.g. a membrane method, in which the remaining substance stream is separated into a phase comprising the remaining triglycerides and into a further substance stream comprising glycerol. If appropriate, glycerol is already obtained in pure form from the further substance stream following separation (5). The phase comprising the remaining triglycerides is then passed to the further reaction (transesterification) and afterwards passed together with the further substance stream from the separation (5) to a separation (4), e.g. in the form of an alcohol distillation. The alcohol lost in the separation (2) and, if appropriate, separation (5) is in turn again added to the further reaction (transesterification).

The free fatty acids resulting from the separation (1) are firstly passed to a reaction (esterification) together with alcohol. The product of the reaction (esterification) is then passed to a separation (3), e.g. in the form of an evaporation, in which, if appropriate, alcohol and water which has formed during the reaction (esterification), are separated off from the remaining substance stream comprising free acids. The substance stream comprising free fatty acids is passed with the further addition of alcohol to a further reaction (esterification) while the separated-off substance stream comprising, if appropriate, alcohol and water is passed to the separation (4). The separation (4) then separates the substance streams combined in this step into alcohol, which can be passed to the reservoir and, if appropriate, be reused in the process, and remaining substance stream comprising fatty acid alkyl ester and glycerol, such that these are present in different phases. This two-phase system is then passed to the separation (membrane method), from which then glycerol and fatty acid alkyl ester are obtained in pure form.

### Example 3

### Reaction in Step c) with Alternative, Basic, Heterogeneous Catalyst

### Preparation of the Catalyst

174.9 g of lanthanum nitrate hexahydrate were dissolved in 60 g of distilled water and 31.2 g of magnesium oxide were added. The resulting mixture was stirred for 30 min at room temperature (23° C.).

24 g of nitric acid (65% by weight in water) were dissolved in 216 g of distilled water. This acid solution was combined with the above-prepared mixture and 224 g of dry aluminium oxide. The resulting mixture was stirred for 75 min at room temperature (23° C.).

The solid was then separated off by filtering over a paper filter. The resulting moist solid was dried at 100° C. for 4 h in ambient air.

Drying was subsequently carried out for 3 h at 150° C. The solid was then heated to 700° C. with a temperature ramp of 7° C./min. The end temperature of 700° C. was held for 2 h. Finally, the solid was calcined for 4 h at 1000° C.

The catalyst obtained was converted to a soluble form by means of microwave digestion (DIN EN 14084). The content determination was carried out by means of ICP-OES using an instrument from Perkin Elmer (Optima 3300 XL) analogously to DIN EN ISO 11885 and revealed the composition according to Table 1.

TABLE 1
Content of elements in the catalyst
analogously to DIN EN ISO 118855

| Substance | Mol % | % by wt. |
|---|---|---|
| Al | 30.8 | 39 |
| La | 1.3 | 8.2 |
| Mg | 4.4 | 5 |
| O | 63.5 | 47.8 |
| Σ | 100 | 100 |

The fractions obtained give rise to the theoretical fractions of the corresponding oxides according to Table 2:

TABLE 2
Theoretical fractions of the corresponding oxides

| Substance | % by wt. |
|---|---|
| Al₂O₃ | 80.4 |
| La₂O₃ | 10.5 |
| MgO | 9.1 |
| Σ | 100 |

The powder was characterized by means of powder X-ray spectroscopy (p-XRD). For this, a Siemens D 5000 theta-theta-reflection diffractometer was used. The measurement parameters as in Table 3 were used.

TABLE 3
Measurement parameters of the Siemens D 5000
theta-theta-reflection diffractometer

| Measurement parameter | Value |
|---|---|
| Radiation source | Copper, K-alpha |
| Wavelength | 1.5406 Å units |
| Measurement range (in 2 Θ) | 2-80° |

It was established that the analysed powder consisted of the phases according to Table 4:

TABLE 4
Constituents of the catalyst according to Example 1

| Phase name | Formula | Number* |
|---|---|---|
| Aluminium oxide | Al₂O₃ | 00-001-1303 |
| Crawfordite (spinell) | Mg_{0.36}Al_{2.44}O₄ | 01-077-0729 |
| Magnesium oxide (Periklas) | MgO | 00-045-0946 |
| Lanthanum-aluminium oxide | LaAlO₃ | 01-070-6996 |
| (Perovskite) | | |
| Lanthanum oxide | La₂O₃ | 01-074-2430 |

*according to nomenclature of the International Centre for Diffraction Data

The aluminium oxide referred to according to the nomenclature of the International Centre for Diffraction Data as 00-001-1303 is γ-Al₂O₃.

The resulting catalyst powder was furthermore analysed to determine its fraction of mesopores by means of mercury porosimetry. For this, 0.3287 g of the resulting catalyst powder were introduced into a mercury porosimeter (model: combination of the Pascal 140/440 porosimeter; Thermo Electron Corp.) and analysed from 140 mbar to 4000 bar in an intrusion measurement with subsequent extrusion measurement of mercury into the pore volumes. The result of the intrusion measurement results in the fact that the catalyst has virtually no micropores and that it has a fraction of only about 4% pores with a diameter greater than 50 nm. The catalyst according to the invention thus has a fraction of about 96% mesopores.

### Reaction According to Step c) Over the Catalyst

A 1 l stirred reactor was filled with 400 g of rapeseed oil raffinate, 333 g of methanol and 40 g of catalyst as in Example 1. The stirred reactor was heated to 200° C. with stirring. The stirring rate was 1000 rpm.

After 135 min at 200° C., the rapeseed oil methyl ester fraction of the oil phase was 90.3% by weight. The fraction was determined in accordance with DIN EN 14103. This gives an activity of 4 kg/kg_{catalyst}·h.

The metal content in the rapeseed oil methyl ester phase was determined by means of ICP-OES (Perkin Elmer, Optima 3300 XL) in accordance with DIN EN ISO 11885, after the rapeseed oil methyl ester phase had been converted to a water-soluble form by means of microwave digestion (DIN EN 14084). The concentrations of all catalyst metals (La, Al, Mg) in the rapeseed oil methyl ester phase were less than 1 ppm.

It was thus demonstrated that the catalyst according to Example 1 surprisingly has a high activity and at the same time no leaching.

1. Process for the preparation of fatty acid alkyl esters starting from starting materials which include at least a fraction of triglycerides of fatty acids and/or a fraction of free fatty acids, comprising at least the steps:
a) reacting the free fatty acids with an alcohol in an esterification reaction in the presence of an acidic, heterogeneous catalyst to form fatty acid alkyl esters,
b) optionally removing water and/or alcohol from the product of step a),
c) reacting the triglycerides with an alcohol in a transesterification reaction in the presence of a basic, heterogeneous catalyst, to form fatty acid alkyl esters,
d) optionally removing the alcohol from the product of step c),
e) separating off glycerol using a hydrophobic membrane.

2. Process according to claim 1, wherein said alcohols are monoalcohols containing at most five carbon atoms.

3. Process according to claim 1 or 2, wherein the acidic, heterogeneous catalyst comprises polymers with acidic side groups.

4. Process according to claim 3, wherein the acidic, heterogeneous catalyst is in the form of particle beds as solid bed in the reaction zone.

5. Process according to claim 1, wherein the basic, heterogeneous catalyst comprises salts and/or oxides of metals selected from the group consisting of aluminium, calcium, chromium, iron, gallium, cobalt, copper, lanthanum, magnesium, manganese, nickel, vanadium and zinc or mixtures of said salts and/or oxides.

6. Process according to claim 5, wherein the basic heterogeneous catalyst comprises lanthanum oxide (La₂O₃) and aluminium oxide (Al₂O₃) and, optionally, magnesium oxide (MgO) and wherein the sum of the mass fractions of lanthanum oxide and magnesium oxide is between 2 and 20%.

7. Process according to claim 5, wherein the basic, heterogeneous catalyst is a substance which is obtained from hydrotalcites by calcination.

8. Process according to claims 5 to 7, wherein the basic, heterogeneous catalyst is in the form of particle beds as solid bed in the reaction zone.

9. Process according to claim 1, wherein step a) is carried out at temperatures between 50° C. and 120° C.

10. Process according to claim 1, wherein step a) and/or step c) is carried out at a pressure approximately equal to the vapor pressure of the alcohol used in the process.

11. Process according to claim 1, wherein step a) involves at least one further reaction.

12. Process according to claim 7, wherein the at least one further reaction involves at least one reaction according to step a) and at least one prior separation off of water and/or alcohol.

13. Process according to claim 1, wherein the reaction according to step c) takes place at temperatures between 50° C. and 250° C.

14. Process according to claim 1, wherein the reaction according to step c) involves a further reaction.

15. Process according to claim 13, wherein said further reaction involves a reaction according to step c) and a prior separation off of glycerol.

16. Process according to claim 14, wherein the prior separation off of glycerol takes place by means of a multistage method, involving flash evaporation and subsequent separation off of glycerol by means of phase separation.

17. Process according to claim 1, wherein the hydrophobic membrane comprises hydrophobic membranes made of ceramic, polymer, or composite materials made of polymer and ceramic which have a coating with hydrophobic material or whose surface has been hydrophobicized through the use of isocyanates or silanes.

18. Process according to claim 1, wherein, prior to carrying out step a), a separation according to a step f) is carried out in which free fatty acids are separated from triglycerides such that the free fatty acids are passed to step a) and the triglycerides are passed to step c) of the process according to the invention simultaneously.

19. Process according to claim 1, wherein a further step g) is carried out in which the glycerol obtained from step e) is passed to a further reaction.

20. A diesel fuel comprising the fatty acid alkyl ester obtained from the process of claim 1.
